(19) United States
(12) Patent Application Publication
(10) Pub. No.: US 2011/0274183 A1
(43) Pub. Date: Nov. 10, 2011

(54) ANTENNA SELECTION TRAINING PROTOCOL FOR WIRELESS MEDICAL APPLICATIONS

(75) Inventor: Dong Wang, Ossining, NY (US)

(73) Assignee: KONINKLIJKE PHILIPS ELECTRONICS N.V., EINDHOVEN (NL)

(21) Appl. No.: 12/674,541

(22) PCT Filed: Aug. 26, 2008
(86) PCT No.: PCT/IB08/53435

§ 371 Date: Feb. 22, 2010

Related U.S. Application Data
(60) Provisional application No. 60/969,745, filed on Sep. 4, 2007.

(51) Int. Cl. H04L 27/00

(52) U.S. Cl. 375/259

(57) ABSTRACT

In a medical imaging setting, wireless local devices such as probes and local coils are used. As environmental variables may change, signals from the main imaging machine from different locations around the imaging suite are transmitted and received. In determining which of a plurality of locations is best for receiving, a main machine antenna system (26) transmits training request packets from various locations. A wireless transceiver (24) located on a local probe device (22) responds to each training request packet that it receives. By evaluating the responses, the imager can determine which antenna locations are best. A sleep mode and a double-check mechanism are included to improve power consumption, performance, and communication reliability.

The present application relates to the wireless communication arts. It finds particular application in a diagnostic imaging setting where a main diagnostic imaging device communicates wirelessly with a local probe, coil, or the like. It is to be understood, however, that it also finds application in any setting where a wireless device may be queried from multiple communication positions to determine the best transmission pathway.

Wireless communication techniques have been implemented in a wide variety of applications to lend greater freedom to those who take advantage of them. Wireless medical applications have attracted increasing amounts of attention due to their promising market. In medical systems, there are usually a large number of cables connected between probe devices and the main imaging device. The probe devices are in turn attached to patients to collect data. The cables are heavy and are inconvenient for both patients and doctors. In some cases, for example in MRI systems, these cables can become overheated and injure patients. Thus, it would be desirable to replace these cables with wireless modules. The ultra-wideband (UWB) technique is a promising candidate due to its low transmission power, high data transmission rate, low cost, and short transmission range, which match the requirements of medical applications quite well.

The wireless medical connectivity solution has a number of key problems, however, that require solving before it can be viable for clinical use. One issue is the reliability of wireless communications. Medical applications typically have much higher reliability requirements compared to consumer electronics applications. For example, in WiMedia UWB communication and wireless LAN systems, the desired performance criterion is the average packet error rate (PER) over 90% in the best channels. Resultantly, those implementations do not guarantee that they can work for all channels. A 90% reliability standard is too low for medical applications. Many medical applications may require the implemented wireless system to have as high as a 99.999% reliability rate for all possible channels. Some types of diversity techniques can be used to increase the reliability of wireless systems. In some systems, a frequency diversity technique is adopted to exploit frequency domain diversity, but is still typically not reliable enough. Current antenna selection algorithms proposed, such as the averaged signal-to-noise ratio (SNR) criterion, cannot guarantee that the selected antenna can support the required data rate. Thus in medical applications, more sophisticated antenna selection protocols are needed.

Another key problem is the power consumption of wireless devices. Being “wireless” means that the devices have to make use of a battery to supply power. Thus, low power consumption is important and must be taken into consideration when designing wireless communication systems for medical applications.

The present application provides a new and improved antenna positioning and querying system that overcomes the above-referenced problems and others.

In accordance with one aspect, an imaging apparatus is provided. A main machine portion includes an antenna system with a plurality of antenna positions and at least one antenna. A wireless local device is located adjacent a subject in an imaging region of the main machine portion, and it has a wireless transceiver for communicating wirelessly with the at least one main machine antenna. An antenna control module causes training request packets to be transmitted from the main machine antenna. A processor at the wireless device that responds to receiving the training request packet by controlling the local device transceiver to transmit an antenna selection training packet to the main machine antenna.

In accordance with another aspect, a magnetic imaging apparatus is provided. A main machine portion excites magnetic resonance in a subject located in an imaging region. A wireless local magnetic resonance receive coil located adjacent the subject receives magnetic resonance from the subject. The apparatus includes a plurality of antenna positions hardwired to the main machine portion. The local receive coil communicates with the main machine portion via at least one antenna located at one of the plurality of antenna positions. A processor determines which of the plurality of antenna positions is optimal for communicating with the local receive coil.

In accordance with another aspect, a method of determining an optimal antenna position in a diagnostic imaging setting is provided. A request to train data packet is transmitted from a first main machine antenna position. The request to train data packet is received with a local device transceiver. An antenna selection training packet is transmitted by the local device transceiver upon receipt of the request to train packet. The antenna selection training packet is received with a main machine antenna located at the main machine antenna position. The integrity of the antenna selection training packet is evaluated to see if it passes at least one antenna training criterion.

In accordance with another aspect, a method of determining an optimal antenna position for wireless data communication is provided. A wireless antenna is placed in a listening mode. A request to train packet is transmitted from a machine antenna in a first machine antenna position. The request to train packet is received with the wireless antenna. An antenna selection training packet is sent by the wireless antenna. The antenna selection training packet is received with the machine antenna. The antenna selection training packet is evaluated to see if it passes at least one selection criterion. The first machine antenna position is placed on a valid antenna position list if it passes at least one selection criterion. The verification steps are repeated for at least a second machine antenna location. All antenna positions on the valid antenna position list are sorted. A double check packet is sent from a first machine antenna position from the valid antenna location list. The double check packet is received with the wireless antenna. A double check acknowledgement packet is sent with the wireless antenna. The double check acknowledgement packet is evaluated. A data transmission phase is commenced where substantive data is transmitted from the wireless antenna to one of the valid antenna locations.

One advantage lies in automated determination of the best antenna communication positions.

Another advantage lies in increased reliability of data communications.

Another advantage lies in increased battery life for wireless devices.

Another advantage lies in reduced implementation cost.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

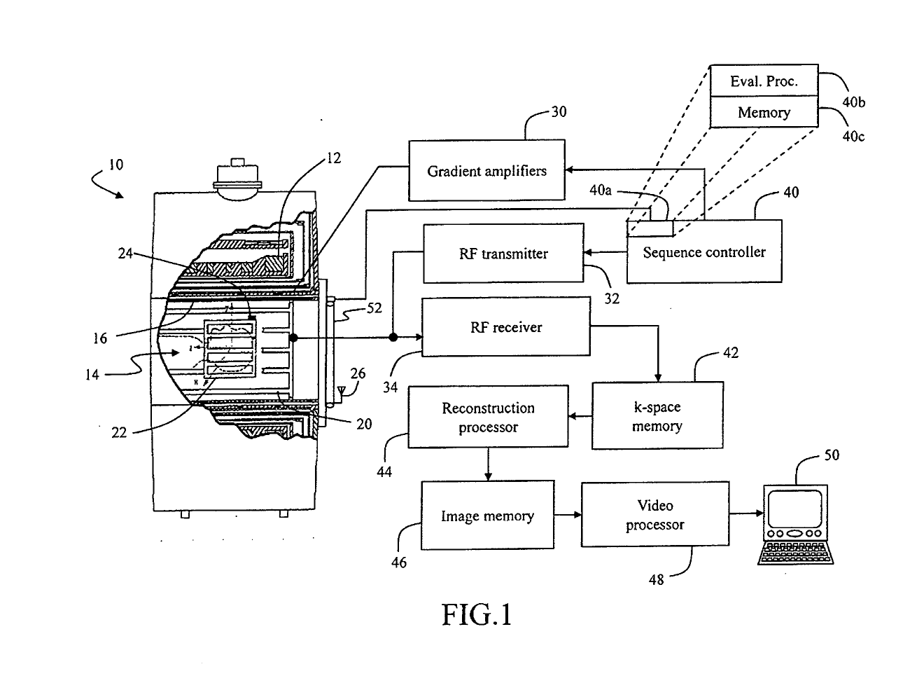

FIG. 1 is a diagrammatic illustration of a magnetic resonance scanner;

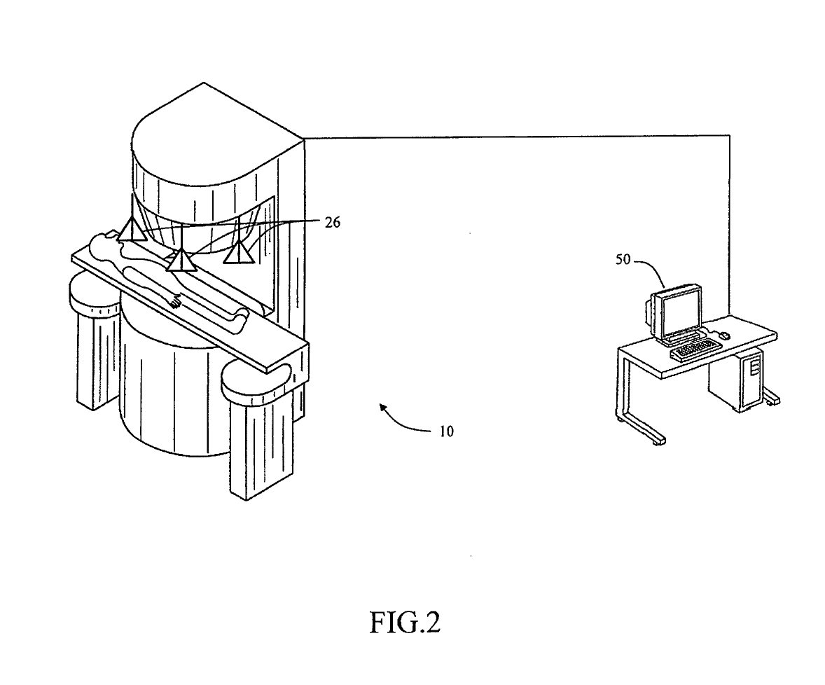

FIG. 2 is a perspective view of an imaging suite in accordance with the present application;

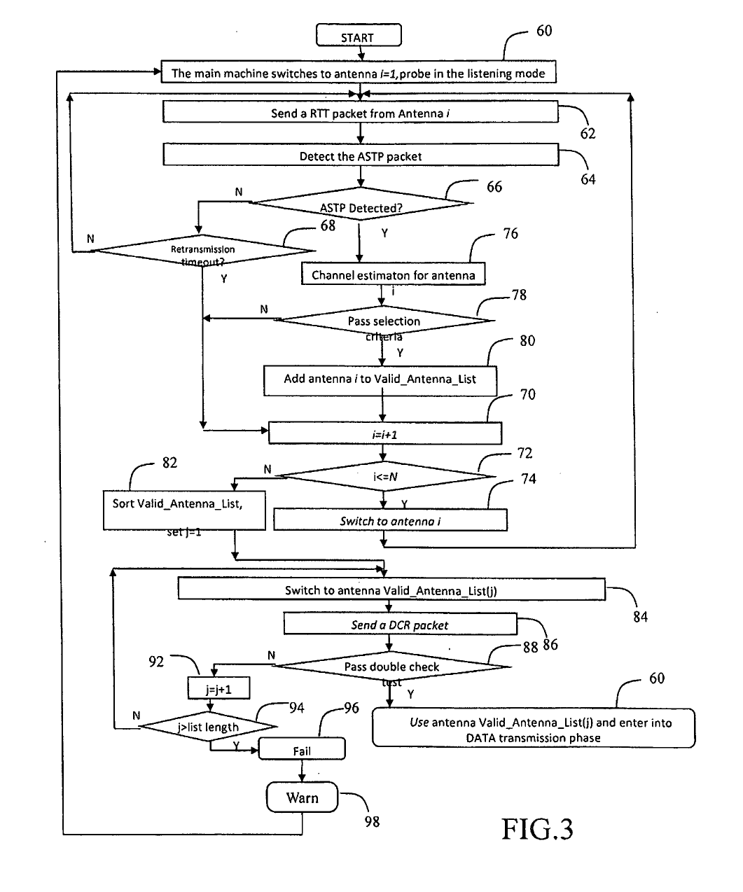

FIG. 3 is a flow diagram that outlines an antenna selection technique.

With reference to FIG. 1, a magnetic resonance scanner 10 includes a cylindrical main magnet assembly 12. The main magnet assembly 12 is preferably a superconducting cryoshielded solenoid, defining a bore 14 into which a subject is placed for imaging. The main magnet assembly 12 produces a substantially constant main magnetic field oriented along a longitudinal axis of the bore 14. Although a cylindrical main magnet assembly 12 is illustrated, it is to be understood that other magnet arrangements, such as vertical field, open magnets, non-superconducting magnets, and other configurations are also contemplated. Additionally, other diagnostic imaging systems that can utilize wireless communications could be used, such as CT, PET, SPECT, x-ray, ultrasound, and others.

A gradient coil 16 produces magnetic field gradients in the bore 14 for spatially encoding magnetic resonance signals, for producing magnetization-spoiling field gradients, or the like. Preferably, the magnetic field gradient coil 16 includes coil segments configured to produce magnetic field gradients in three orthogonal directions, typically longitudinal or z, transverse or x, and vertical or y directions.

A whole body radio frequency coil assembly 18 generates radio frequency pulses for exciting magnetic resonance in dipoles of the subject. The radio frequency coil assembly 18 also serves to detect magnetic resonance signals emanating from the imaging region. A radio frequency shield 20 is placed between the RF coils 18 and the gradient coils 16. An additional wireless device 22, such as a local coil array 22, (illustrated as a head coil), is located within the bore 14 for more sensitive, localized spatial encoding, excitation, and reception of magnetic resonance signals. Various types of local coil arrays are contemplated such as a simple surface RF coil with one output, a quadrature coil assembly with two outputs, a phased array with several outputs, a SENSE coil array with dozens of outputs, combined RF and gradient coils with both outputs and inputs, and the like. Additionally, the wireless device 22 is not restricted to a local RF coil, but can be any wireless device, such as a local SpO₂ sensor, thermometer, blood pressure cuff, ECG sensors, or the like. The local coil 22 is equipped with a wireless transceiver 24 to send and receive communications to and from at least one antenna 26 located outside the imaging region, in close proximity to the magnetic resonance scanner 10, e.g. adjacent the service end of the bore.

Gradient pulse amplifiers 30 deliver controlled electrical currents to the magnetic field gradient coils 16 to produce selected magnetic field gradients. The gradient amplifiers also deliver electrical pulses to the gradient coils of local coil arrays that are equipped with gradient coils. A radio frequency transmitter 32, preferably digital, applies radio frequency pulses or pulse packets to the radio frequency coil assembly 18 to generate selected magnetic resonance excitations. A radio frequency receiver 34 is wirelessly coupled to the local coil 22 to receive and demodulate the induced magnetic resonance signals. Optionally, the whole body coil 18 is connected to the receiver in a wired interconnection.

To acquire magnetic resonance imaging data of a subject, the subject is placed inside the magnet bore 14, with the imaged region at or near an isocenter of the main magnetic field. A sequence controller 40 communicates with the gradient amplifiers 30 and the radio frequency transmitter 32 to produce selected transient or steady-state magnetic resonance sequences, to spatially encode such magnetic resonances, to selectively spoil magnetic resonances, or otherwise generate selected magnetic resonance signals characteristic of the subject. The generated magnetic resonance signals are detected by the local coil 22, wirelessly transmitted to the antenna 26, communicated to the radio frequency receiver 34, and stored in a k-space memory 42. The imaging data is reconstructed by a reconstruction processor 44 to produce an image representation that is stored in an image memory 46. In one suitable embodiment, the reconstruction processor 44 performs an inverse Fourier transform reconstruction.

The resultant image representation is processed by a video processor 48 and displayed on a user interface 50 equipped with a human readable display. The interface 50 is preferably a personal computer or workstation. Rather than producing a video image, the image representation can be processed by a printer driver and printed, transmitted over a computer network or the Internet, or the like. Preferably, the user interface 50 also allows a radiologist or other operator to communicate with the magnetic resonance sequence controller 40 to select magnetic resonance imaging sequences, modify imaging sequences, execute imaging sequences, and so forth.

A multiple antenna system technique may be implemented for medical applications to achieve the required communication reliability. Among all possible multiple antenna transmission schemes, antenna selection is a good choice for its low implementation complexity. In medical systems, the communication pattern is asymmetric and most of communication is on the uplink, which is from the probe device to the main machine. Thus, a single antenna can be used on the probe side while multiple antennas can be used at the main machine side so that the receiving antenna can be selected.

In the illustrated embodiment, the local coil 22 via the wireless transceiver module 24 communicates via the antenna 26 with the receiver 34 and the sequence controller 40. This multiple antenna system 26 can be a real multiple antenna system with N actual antennae with an RF switch so that only one RF chain is needed, or a “virtual” multiple antenna system, which only has one real antenna but it can move to N different sites to simulate N independent antennae. Such an antenna could be moved around a track 52, disposed encircling an end of the bore, such as the service end, as illustrated in FIG. 1. The local coil transceiver 24 can work in three modes: listening mode, transmit mode and sleep mode.

Alternately, as illustrated in FIG. 2, the antenna system can include a plurality of antennae 26′.

By way of a brief overview, with continuing reference to FIG. 1, in a pre scanning set up mode, an antenna control subsystem 40a of the controller 40 causes a transceiver associated with the antenna 26 to transmit signals to the transceiver 24. A processor in the transceiver 24 responds with a data packet. An evaluation processor 40b of the antenna control module evaluates how accurately the received test signal matches the known test signal. The antenna control module then moves the antenna 26 to another position or switches to another of the fixed antennae 26′ and repeats the process. the relative quality of the data received by each antenna or in each positions stored in a memory or a table 40c.

During imaging, the antenna control module selects the best antenna/antenna location from the memory 40c. The transceiver 24 stores the resonance data in an on board memory and transmits it in packets. The data evaluation processor 40b analyzes each received resonance signal and determines if it is of acceptable accuracy to be conveyed to the receiver 34. If it is not, the antenna 26 tries again to send the data. If after a selected number of tries, a satisfactory transmission accuracy is not obtained, the antenna control module 40a switches to the next best antenna/antenna position listed in memory 40c and tries again. This process is repeated with other antennae/antenna locations as may be necessary to obtain data packets with a selected level of accuracy.

With reference now to FIG. 3, looking at the process in more specific detail, at the beginning of an antenna position selection process, the local coil transceiver 24 enters the listening mode and the main machine antenna 26 that is connected with the antenna system enters sleep mode. When the patient is moved to a proper position for imaging, and the attendant starts a measurement operation, the main machine antenna 26 wakes up and switches to a first antenna position (i=1) 60. From the first position, the antenna 26 starts to transmit a request-to-train (RTT) signaling packet 62. After the transmission, the main machine antenna 26 switches to the listening mode and listens for the response packet from the local coil 22. If the local coil transceiver 24 detects the RTT packet correctly, then the local coil transceiver 24 will transmit an antenna-selection-training packet (ASTP) 64 to the main machine to help it estimate the channel between the local coil 22 and the current antenna position of the main machine. In the RTT packet, there is a sleep timer value Tₛ.

After finishing the ASTP transmission, the local coil transceiver 24 will put itself in sleep mode for a period of Tₛ. This helps the local coil 22 conserve battery power. The controller 40 uses the time period Tₛ to evaluate the ASTP packet and do antenna switching (either physically move the antenna, in a one antenna embodiment, or switch channels in a multiple antenna embodiment). If a virtual multiple antenna system is used, the main machine can use this time to move the antenna 26 around. The moving time may be relatively long for the virtual multiple antennae case, and by putting the local coil transceiver 24 into a sleep mode, the local coil transceiver 24 can conserve power. After the period of Tₛ passes, the local coil transceiver 24 switches to the listening mode again and listens for the next communication from the main machine antenna 26.

The main machine antenna 26 attempts to detect the ASTP packet 66. If the ASTP packet is not detected, the process times out 68. The antenna position is moved 70 to the next antenna position or “switched” to the next antenna 26′ and an RTT packet is again transmitted. If the main machine does not detect the ASTP packet, and the retransmission process has not timed out, the main machine will attempt the RTT from the same position. The main machine antenna 26 will retransmit the RTT for as long as time allows, and if all of them fail, the main machine will evaluate the current antenna or antenna position as a failure and switch to the next available antenna or antenna position 70. The main machine checks to see if there are any antennae or antenna positions that it has not tried 72. If there is at least one additional antenna 26′ or antenna position, the main machine switches to that antenna 74 and starts the process over.

From the new antenna position, the main machine antenna 26 transmits the RTT packets again. If the local coil 22 receives multiple RTTs from the same antenna 26 (there is an antenna index field in the RTT packet) and has previously sent an ASTP response, the local coil 22 will keep quiet to let the main machine fail the current antenna. In such a situation, if the main machine did not receive the ATSP, it is presumably not an optimal position.

If the ATSP is received by the main machine antenna 26 in step 66, the main machine estimates a channel accuracy 76 for the current antenna 26′ or antenna position. The evaluation processor 40b checks to see if the ATSP passes selection criteria 78. Possible criteria can include the average signal-to-noise ratio, the worst signal-to-noise ratio of multiple data sub-carriers in OFDM systems. All the antenna candidates passing selection criteria are sorted 82 based on the above criteria and stored in a valid antenna list in the memory 40c. In one embodiment, the valid antenna positions are sorted according to their position. If the selection criteria fail, then the main machine moves on to the next antenna 26′ or antenna position.

Based on the measured channels, the main machine builds up a valid antenna candidate table, which includes all antennae (or positions in the virtual multiple antenna case) that are determined to be able to support the desired data rate. The main machine selects the best antenna in the valid antenna list and switches to it 84. In order to guarantee the selected antenna can achieve the required reliability, a “double-check” procedure is used to check the communication reliability. After switching to the selected antenna, the main machine transceiver 26 will transmit a “double-check-request” (DCR) packet 86 to the local coil 22. If the local coil 22 received the DCR packet correctly, it will transmit a predefined data packet with a desired data rate, which will be used to transmit real resonance data in the following data transmission phase. If the main machine received this predefined pseudo-data packet (DCTP) correctly meaning that the local coil 22 passed the double check 88, then the main machine can either confirm that the selected antenna 26 is good enough and send a double check acknowledgement to the local coil to close the antenna selection training phase and enter into the data collection phase 90. Optionally, the main machine can retransmit the DCR to double-double-check. If the main machine detects that the received pseudo-data packet is in error and the bit error rate (BER) is higher than the required BER, or it does not detect the pseudo-data packet, then the main machine will assess that the current selected channel cannot support the forthcoming data transmission and switch to the next optimal antenna 92 in the valid antenna list and repeat the “double-check” procedure. The main machine checks all the valid positions until the valid antenna list is exhausted 94. If all the antennas 26 or positions in the valid antenna list fail in the “double check” procedure, the antenna selection process ends in failure 96. In such a situation, the main machine can output a warning message 98 and move the patient a small amount to change the channels, or direct the user to reposition the patient, deploy actual antennae differently, and the like. Then the antenna selection procedure is repeated.

Despite the rigorous antenna selection process, it is possible that some transmissions may not be complete. In one embodiment, the local coil 22 houses an on-board memory so that it may re-transmit resonance data upon request by the main machine if data gets lost or corrupted.

In another embodiment, when the main machine gets the first valid antenna candidate, it will switch to double-check procedure 86 directly. If the current antenna 26 or position passes the double-check procedure, it will use the current selected antenna immediately to do data transmission. If the antenna 26 fails in the double-check procedure, the main machine will move to the next available antenna and do antenna selection training procedure again. This embodiment can reduce the antenna selection training protocol running time, as it will interrupt the process as soon as the first acceptable antenna 26 or position is found. In the unlikely event that a certain antenna 26′ or antenna position becomes unsatisfactory, the antenna control processor 40c can send a feedback message to the sequence controller 40 to have the pulse sequence paused while it selects the next antenna 26′ or antenna position from the list. Once the next one is ready, the antenna control processor 40c informs the sequence controller 40 that it can restart the sequence.

The described embodiments can be used for wireless medical applications, such as wireless MRI and wireless ultrasound systems, in which multiple antennae are used at the main machine side and a receiver antenna selection scheme is used. In many medical applications, the environment is static or quasi-static, which means the environment does not appreciably change over time. At the very least, it will not appreciably change over the time of a single scan. Interventional procedures may result in movement of equipment or personnel that can adversely affect the accuracy of data received. Thus, multiple antenna diversity (or spatial diversity) is a promising choice. Multiple antenna systems can provide high diversity order, such as space-time coding and antenna selection algorithms. Antenna selection is a more attractive solution since it can achieve the same diversity order as the optimal space-time coding technique with only one RF chain and nearly the same baseband signal processing complexity as that of the single antenna case, resulting in lower implementation cost.

The above-described embodiments put as many as possible power-consuming tasks to the main machine side, which uses AC power. Multiple antennas or a virtual antenna array can be utilized at the main machine side while only one antenna is used at the probe side to reduce the power consumption. In such a multiple probe embodiment, the probes may be linked or have very low power transmitters to transmit to another, master probe located in close proximity, which could carry a more powerful transceiver.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. An imaging apparatus comprising:
a main machine portion that includes an antenna system with a plurality of antennae positions and at least one antenna;
a wireless local device located adjacent a subject in an imaging region of the main machine portion, the wireless local device having a wireless transceiver for communicating wirelessly with the at least one main machine antenna;
an antenna control module which causes training request packets to be transmitted from the main machine antenna; and,
a processor of the wireless device that responds to receiving the training request packet by controlling the local device transceiver to transmit an antenna selection training packet to the main machine antenna.

2. The imaging apparatus as set forth in claim 1, further including a data evaluation processor that evaluates the antenna selection training packet to verify that it meets communication criteria.

3. The imaging apparatus as set forth in claim 2, wherein antenna control module further controls the main machine antenna to send a double check packet to the local device if the antenna selection training packet meets the communication criteria.

4. The imaging apparatus as set forth in claim 3, wherein the local device processor controls the local device transceiver to send a double check acknowledgement packet upon receiving a double check packet.

5. The imaging apparatus as set forth in claim 2, wherein the antenna control module moves the antenna to a next position of the plurality of antenna positions on an antenna track.

6. The imaging apparatus as set forth in claim 5, wherein the antenna control module controls the main machine antenna to transmit a new request to train packet from the next position.

7. The imaging apparatus as set forth in claim 5, wherein the local device enters a sleep mode while the position of the antenna changes.

8. The imaging apparatus as set forth in claim 5, wherein the antenna track includes antenna positions that have lines of sight to the wireless transceiver.

9. The imaging apparatus as set forth in claim 1 further including:
a plurality of main machine antennae located at various points about an imaging suite in which the main machine portion is located.

10. The imaging apparatus as set forth in claim 1, wherein the processor is located on the local coil.

11. The imaging apparatus as set forth in claim 1, wherein the processor is located remote from the local coil on the main machine portion.

12. A magnetic imaging apparatus comprising:
A main machine portion for exciting magnetic resonance in a subject located in an imaging region;
a wireless local magnetic resonance receive coil located adjacent the subject for receiving magnetic resonance from the subject;
a plurality of antenna positions hardwired to the main machine portion, the local receive coil communicating with the main machine portion via at least one antenna located at one of the plurality of antenna positions;
a processor for determining which of the plurality of antenna positions is optimal for communicating with the local receive coil.

13. The magnetic imaging apparatus as set forth in claim 12, further including:
a main magnet for creating a substantially uniform main magnetic field in an imaging region of the apparatus;
a gradient coil assembly for inducing gradient magnetic fields on the main magnetic field;
a radio frequency coil assembly for at least transmitting radio frequency signals into the imaging region for inducing magnetic resonance in the subject; and
a reconstruction processor that reconstructs magnetic resonance signals from at least the local coil into an image representation of a portion of the subject in the imaging region.

14. A method of determining an optimal antenna position in a diagnostic imaging setting comprising:
a) transmitting a request to train data packet from a first main machine antenna position;
b) receiving the request to train data packet with a local device transceiver;
c) transmitting an antenna selection training packet with the local device transceiver upon receipt of the request to train packet;
d) receiving the antenna selection training packet with a main machine antenna located at the main machine antenna position;
e) evaluating the integrity of the antenna selection training packet to see if it passes at least one antenna training criterion.

15. The method as set forth in claim 14, wherein upon passing the at least one antenna training criterion the first main machine antenna position is added to a valid antenna position list, and steps b)-e) are repeated from a second main machine antenna position.

16. The method as set forth in claim 15, further including:
sorting all main machine antenna positions included in the valid antenna position list.

17. The method as set forth in claim 15, further including:
transmitting a double check packet from a first antenna position from the valid antenna position list.

18. The method as set forth in claim 17, further including:
receiving a double check acknowledgement from the local device transceiver.

19. The method as set forth in claim 18, further including:
commencing a diagnostic imaging scan wherein the local device gathers information pertinent to the scan and transmits it to the main machine antenna position.

20. The method as set forth in claim 15, wherein antenna locations are changed during a diagnostic imaging scan in the order of the positions on the valid antenna position list.

21. The method as set forth in claim 14, wherein upon failing the at least one antenna training criterion, steps b-e are repeated from a second main machine antenna position.

22. The method as set forth in claim 14, further including:
inducing a sleep mode in the local device for a predetermined period of time after the local device transceiver transmits the antenna selection training packet.

23. A method of determining an optimal antenna position for wireless data communication comprising:
a) placing a wireless antenna in a listening mode;
b) transmitting a request to train packet from a machine antenna in a first machine antenna location;
c) receiving the request to train packet with the wireless antenna;
d) sending an antenna selection training packet with the wireless antenna;
e) receiving the antenna selection training packet with the machine antenna;
f) evaluating the antenna selection training packet to see if it passes at least one selection criterion;
g) placing the first machine antenna location on a valid antenna position list;
h) repeating steps a)-g) for at least a second machine antenna location;
i) sorting antenna positions on the valid antenna position list;
j) sending a double check packet from a first machine antenna position from the valid antenna position list;
k) receiving the double check packet with the wireless antenna;
l) sending a double check acknowledgement packet with the wireless antenna;
m) evaluating the double check acknowledgement packet;
n) commencing a data transmission phase where substantive data is transmitted from the wireless antenna to one of the valid antenna positions.
